(19) United States
(12) Patent Application Publication
(10) Pub. No.: US 2013/0204701 A1
(43) Pub. Date: Aug. 8, 2013

(54) APPARATUS, SYSTEM AND METHODS FOR MARKETING TARGETED PRODUCTS TO USERS OF SOCIAL MEDIA

(71) Applicants: Gianmauro Calafiore, Milano (IT); Bart Michael Peintner, Palo Alto, CA (US)

(72) Inventors: Gianmauro Calafiore, Milano (IT); Bart Michael Peintner, Palo Alto, CA (US)

(21) Appl. No.: 13/761,121

(22) Filed: Feb. 6, 2013

Related U.S. Application Data
(60) Provisional application No. 61/595,682, filed on Feb. 6, 2012.

(51) Int. Cl. G06Q 30/02; G06Q 50/00

(52) U.S. Cl. CPC G06Q 30/0269; G06Q 50/01
USPC 705/14.53; 705/14.66

(57) ABSTRACT

The present invention is directed to a system for marketing targeted products to users of an Internet-based social media community. The system may include a Recommendation, Advertisement, and Personalization (RAP) Engine for generating product recommendations. The RAP Engine may be connected to a Person Shopping Genome Sequence Repository, a Product Genome Sequence Repository, a Merchant Product's Price List Repository and a Genome Annotation Data Repository. The system may include an AI and Semantic Engine connected to the Genome Annotation Data Repository, the Product Genome Sequence Repository, and the Merchant Product's Price List Repository. Also, the system may include a first data channel connected to the RAP Engine for communicating product recommendations to users of an Internet-based social media community.

### CROSS REFERENCE TO RELATED APPLICATIONS

This application claims the benefit of U.S. patent application Ser. No. 61/595,682 filed on Feb. 6, 2012, the entire disclosure of which is incorporated by reference herein.

### FIELD OF THE INVENTION

The present invention generally relates to an apparatus, system, and methods for marketing targeted products to users of an Internet based social media community. More particularly, this invention relates to an apparatus, system, and methods for collecting communications exchanged by users of an Internet based social media community, generating a collection of purchase decision profiles for each of those users, researching market conditions for a set of goods and services, and transforming these data into individually customized offers to buy or sell goods and services to those users and their social network contacts.

### BACKGROUND

Techniques exist for identifying items that a consumer might enjoy in view of other items the consumer has previously indicated he or she enjoys. Some such techniques compare attributes of items the consumer previously indicated he or she enjoys with attributes of other items to identify items that the consumer might enjoy. Nevertheless, there exists a need for systems and methods which generate and deliver product recommendations to users of Internet-based social networks.

### SUMMARY

Hence, the present invention is directed to a system for marketing targeted products to users of an Internet-based social media community.

In one embodiment, the system may include a Recommendation, Advertisement, and Personalization (RAP) Engine for generating product recommendations. The RAP Engine may be connected to a Person Shopping Genome Sequence Repository, a Product Genome Sequence Repository, a Merchant Product's Price List Repository and a Genome Annotation Data Repository.

The system may include an AI and Semantic Engine connected to the Genome Annotation Data Repository, the Product Genome Sequence Repository, and the Merchant Product's Price List Repository. Also, the system may include a first data channel connected to the RAP Engine for communicating product recommendations to users of an Internet-based social media community.

In another aspect of the invention, the RAP Engine may be configured and adapted to perform distance search calculations involving data stored in the Person Shopping Genome Sequence Repository, the Product Genome Sequence Repository, the Merchant Product's Price List Repository, and the Genome Annotation Data Repository.

In another aspect of the invention, the Person Shopping Genome Sequence Repository may house a plurality of Person Shopping Genome Sequences, and the RAP Engine may be configured and adapted to perform distance search calculations which include calculating a Product Affinity Genome Model, and then calculating a second distance between one of the plurality of Person Shopping Genome Sequences and the Product Affinity Genome Model.

### DESCRIPTION OF THE DRAWINGS

The accompanying drawings, which are incorporated herein and constitute part of this specification, illustrate an embodiment of the invention, and together with the general description given above and the detailed description given below, serve to explain the features of the invention.

FIG. 1 is a block diagram of system components and processes of an exemplary embodiment of the present invention in relation to users of a social network, Internet merchants, and goods and services offered for sale via the Internet;

FIG. 2 is a process flow chart of the continuous data analysis aspect of FIG. 1;

FIG. 3 is a block diagram of three aspects of the Recommendation, Advertising, and Personalization Engine of FIG. 1;

FIG. 4 is a process flow chart for one recommendation process of the RAP Engine of FIG. 1;

FIG. 5 is a process flow chart for another recommendation process of the RAP Engine of FIG. 1;

FIG. 6 is a process flow chart of another recommendation process of the RAP Engine of FIG. 1;

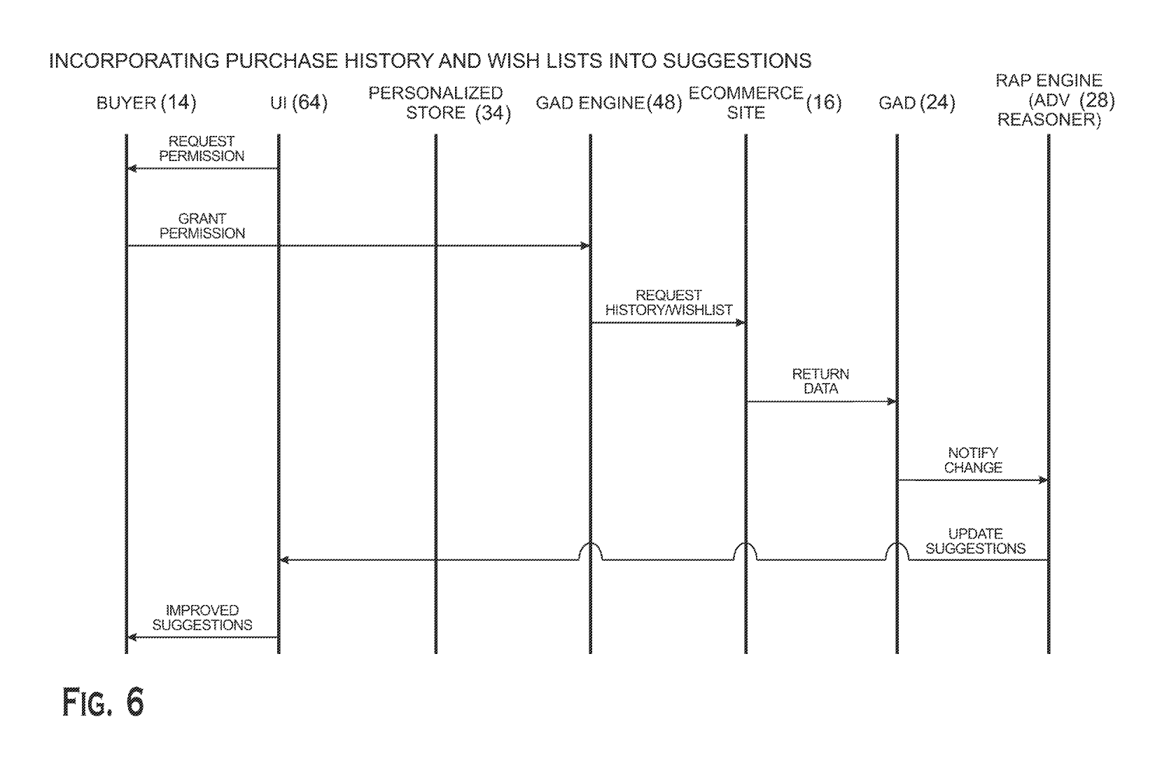

FIG. 7 is a process flow chart of another recommendation process of the RAP Engine of FIG. 1;

FIG. 8 is a schematic diagram of a computer system for implementing the system of FIG. 1.

### DESCRIPTION

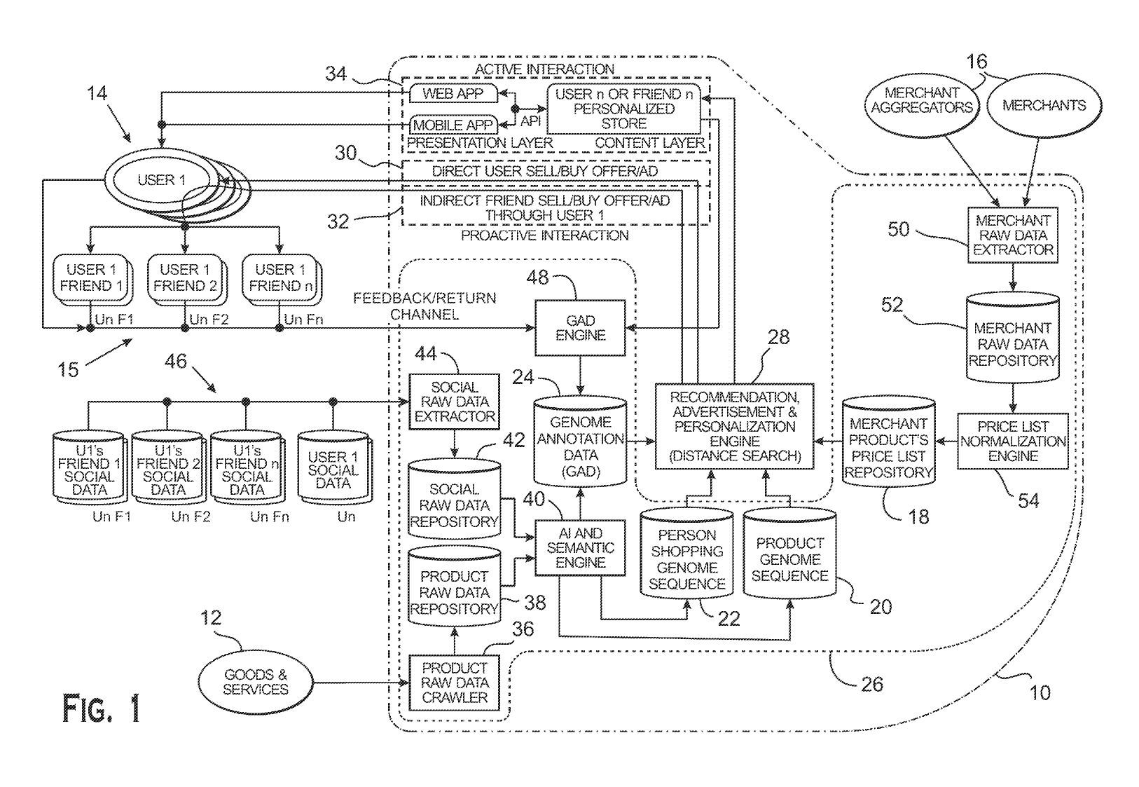

FIG. 1 depicts an exemplary embodiment of a system 10 for marketing of targeted products (e.g., goods or services) 12 to users 14a of an Internet based social media community 14b. In this embodiment, the system 10 may interact with one or more social networks to poll for new social data or communications which are associated with users of the social network and their social network connections (or friends). Additionally, the system 10 may monitor the Internet for new products and new information relating to known products and merchants 16. As new data are uncovered, the system may process the information for storage in a collection of data repositories. Uncovering new data and processing the information may involve the use of an Artificial Intelligence (AI) and Semantic Engine software application.

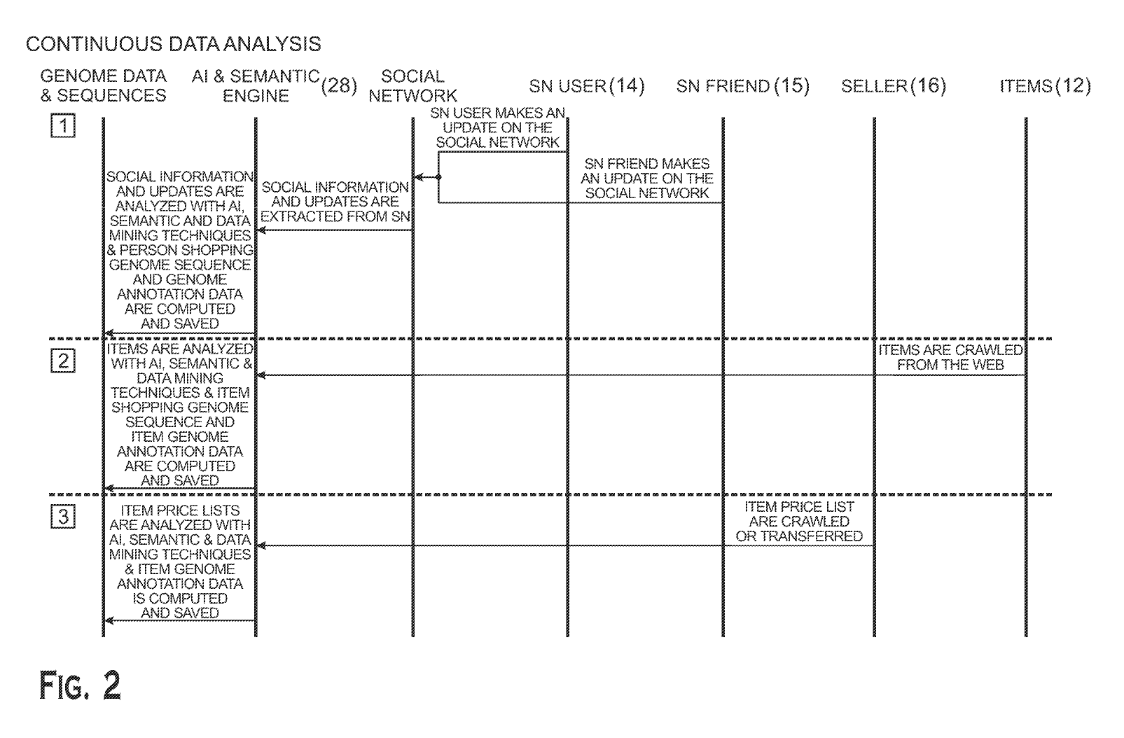

The collection of data repositories (or cylinders) may include, without limitation, a Merchant Product Price List (MPPL) Repository 18, a Product Genome Sequence (PGS) Repository 20, a Person Shopping Genome Sequence (PSGS) Repository 22, and a Genome Annotation Data (GAD) Repository 24 (collectively referred to herein as “the Four Cylinders”). Preferably, these processes may occur continuously as described in connection with FIG. 2 (below). The system components which may be involved in providing continuous data analysis are circumscribed by dashed line 26.

As shown in FIG. 1, the MPPL cylinder, the PGS cylinder, the PSGS cylinder, and the GAD cylinder serve a process called the Recommendation, Advertisement & Personalization (RAP) Engine 28. Generally, the RAP Engine analyzes data from the Four Cylinders and generates product offerings that are considered relevant to a particular user or friend within the social network. The product offerings may include, without limitation, a purchase offer transmitted directly to the user 30, an indirect purchase offer directed to a friend of the user 32, or the deployment of a personalized store 34 for a user (or user's friend) with products considered relevant to the prospective purchaser.

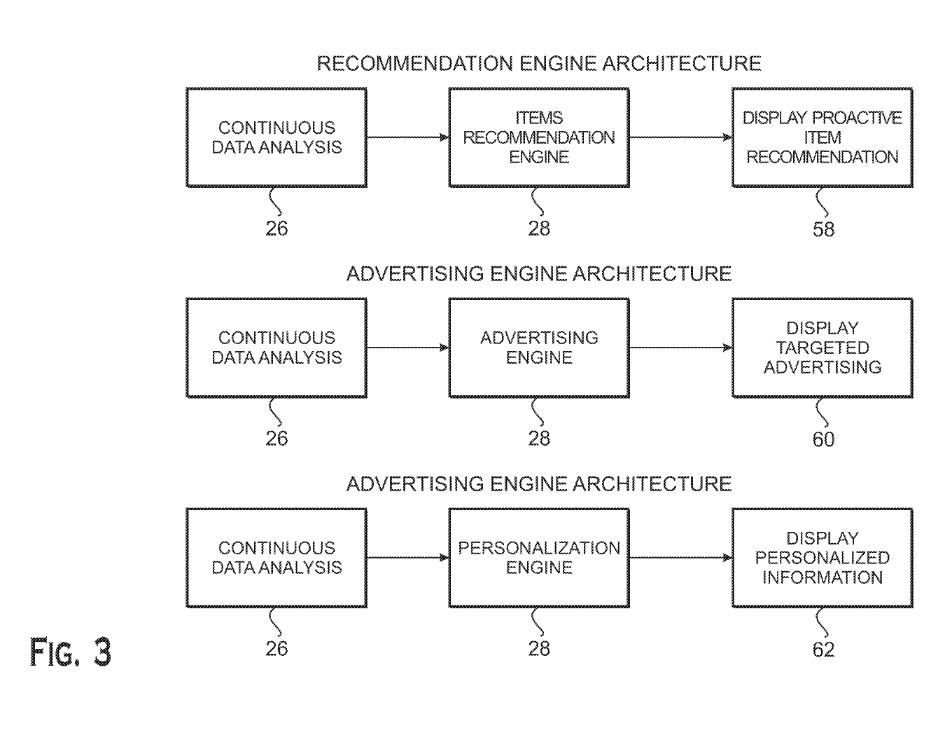

Additionally, the RAP Engine may analyze data from the Four Cylinders to develop a targeted group of users for receipt of advertisements for particular product offerings. FIG. 3 (as described further below) shows the basic RAP Engine architecture for the system. Additionally, the RAP Engine may “learn” from the outcome of its recommendations and “remember” these “experiences” so as to achieve higher efficiency in future recommendations. More specifically, the RAP Engine may use machine learning methods to refine weights that express the affinities between elements of a Person Shopping Genome Sequence and a Product Genome Sequence and store the refined weights in the GAD cylinder.

Accordingly, the exemplary system of FIGS. 1-3 may provide an apparatus for offering users of a social media network a continuously updated and customized series of convertible opportunities that are considered relevant (or even highly suitable) to the users' preferences, aspirations or circumstances. Further information describing the exemplary system of FIGS. 1-3 is provided below.

Referring to FIG. 1, users 14a may be members of a social network. Merchants 16 are sellers of goods and services, which may be purchased by the users. Products are goods and services 12 that are advertised or sold over the Internet through websites. Merchants may be direct sellers or product aggregators.

Product Raw Data Crawler 36 is a process for periodically obtaining aggregate advertising and sales information from the Internet for a targeted list of products. This process periodically searches the Internet and stores web pages from a number of online Merchants (e.g., Amazon or eBay) to create a product raw data set. The stored web pages contain advertising information about products offered by the respective merchants. For example, one web page from an online retailer may include the product name, manufacturer, model number, class of goods or services, price, and a digital image. This process may be performed manually by one or more individuals or by an automated software program that is controllable by a single user.

Product Raw Data Repository 38 is a database that contains product raw data set information from the Product Raw Data Crawler. The information in the Product Raw Data Repository may be updated (in whole or in part) as new datasets are collected by the Product Raw Data Crawler. For instance, the database may be updated periodically during the day or at a selected time.

AI and Semantic Engine 40 is an Artificial Intelligence (AI) and Semantic Engine, which may be implemented using appropriate software. The AI and Semantic Engine may be used to extract and analyze data from the Product Raw Data Repository 38 and Social Raw Data Repository 42. The AI and Semantic Engine may create individual product vectors (or individual Product Genome Sequences) for storage in the Product Genome Sequence Repository. Additionally, the AI and Semantic Engine may be used to extract and analyze data from the Social Raw Data Repository. The AI and Semantic Engine may create individual Person Shopping Genome Sequences, which are then stored in the Person Shopping Genome Sequence Repository. Also, the AI and Semantic Engine may be used to extract and analyze data from the Product Raw Data Repository and the Social Raw Data Repository to generate Genome Annotation Data (GAD).

Product raw data set information in the Product Raw Data Repository 38 may be analyzed by the AI and Semantic Engine, and certain information may be extracted and transformed into Product Genome Sequences, which are then stored in the Product Genome Sequence Repository. For instance, a list of products that appears in the product raw data set with the highest frequency may be created. This list may be a list of the 100 products that appear with the greatest frequency. This list may be identified as the “Top 100” products in the product raw data set. The Top 100 products may be representative of products that are in high demand or are expected to be in high demand by consumers at or near the time the data set is collected.

Additionally, information extracted from the product raw data set may include other categories of data that are considered relevant to a consumer's decision to purchase a product. For example, the identity of the manufacturer, model number, class of goods or services, digital image, average price, and advertised price for each merchant in the data set may be extracted from the data set, normalized and housed in a database. All or part of the information, however, which may be extracted from the product raw data set and housed in the database, may be non-numerical or non-normalized data.

The information extracted from the product raw data may be transformed into Product Genome Sequences. Each sequence may be a data vector that associates a set of numerical values with ordered attributes of a product in the Product Raw Data Repository. For instance, each data vector may be comprised of eleven attributes that are considered relevant to a consumer's willingness to purchase a product. Each of the attributes may be assigned a numerical value ranging between zero and nine. Accordingly, an exemplary data vector may be an eleven digit sequence, and each digit may possess a numerical value equal to 0, 1, 2, 3, 4, 5, 6, 7, 8 or 9.

As described above, each digit in the sequence may represent an attribute of the product. In an illustrative sequence, the first digit of a product vector may represent the product attribute “average price.” The first digit of the product vector would be determined based on the “average price” of that product in the Product Raw Data Repository. For example, a product having an average price ranging from $0.00 to $99.00 may be assigned a numerical value of one. A product having an average price ranging from $100.00 to $150.00 dollars may be assigned a numerical value of two. Similarly, each remaining numerical value between three and nine may be associated with a different average price range. Hence, a product having an average price of $50.00 would have a product vector with a first digit of one, and a product having an average price of $150.00 would have a product vector with a first digit of two.

Creation of the Product Genome Sequences may be performed manually by one or more individuals or by an automated software program. The automated software program may be executed on a general purpose computer that is controlled by a single user. Additionally, the automated software program may utilize an AI and Semantic Engine to extract raw product data, evaluate products in the Product Raw Data Repository, and create the individual product vectors (or individual product genome sequences) for storage in the Product Genome Sequence Repository.

Product Genome Sequence Repository 20 is a database of sequences that are associated with certain products in the Product Raw Data Repository. Each sequence may be a data vector that associates a set of numerical values with ordered attributes of a product in the Product Raw Data Repository. For instance, each data vector may be comprised of eleven attributes that are considered relevant to a consumer's willingness to purchase a product. Each of the attributes may be assigned a numerical value ranging between zero and nine. Accordingly, an exemplary data vector may be an eleven digit sequence, and each digit may possess a numerical value equal to 0, 1, 2, 3, 4, 5, 6, 7, 8 or 9.

Social Network User 14 may be a person who has an account on a social network (e.g., Facebook, Google+ or Twitter) that allows the user to exchange information with other users of the social network. For example, a Facebook user may use a newsfeed to post information to the user's contacts within the social network. The users' contacts can read and post comments about what the user has written or posted and what other contacts have said about it. The newsfeed also allows the user to link to the posts of the user's contacts to see what they have posted and what other contacts said about them.

Social Raw Data Extractor 44 is a process for collecting information exchanged between a user of a social network and the user's contacts. The process involves capturing the exchanged information from the user's account and saving information considered relevant to the communication in a database called the Social Raw Data Repository. The Social Raw Data Extractor also may capture and save information from the user's contacts' newsfeeds. For example, a user of a social network, such as Facebook, may have 120 friends with whom they interact and share information. The user may post or share information with these “friends” on a newsfeed. The user also may access the contacts' newsfeeds. With permission of the user, the Social Raw Data Extractor periodically captures the information on the user's newsfeed, strips out information considered irrelevant to the application, and stores the relevant information in the Social Raw Data Repository database.

Additionally, the Social Raw Data Extractor 44 may capture available information on the newsfeed of each of the user's social contacts, strip out information considered to be irrelevant to the application, and store the information in the Social Raw Data Repository database. Thus, the Social Raw Data Extractor may periodically (e.g., daily) capture and store the user's communications with other members of the social network, as well as periodically capture and store the communications of the user's contacts' in a database.

Social Raw Data Repository 42 is a database that contains captured and filtered, but unedited, communications between users of a social network. The information in the Social Raw Data Repository may be updated (in whole or in part) periodically by the Social Raw Data Extractor. For instance, the database may be updated daily, weekly or at some other time or basis. Social raw data set information in the Social Raw Data Repository may be analyzed by the AI and Semantic Engine, and certain information may be extracted and transformed into Person Shopping Genome Sequences, which are then stored in the Person Shopping Genome Sequence Repository.

A Person Shopping Genome Sequence may be a data vector that associates a normalized set of numerical values with ordered attributes for one social network user based on information in the Social Raw Data Repository. For instance, each data vector may include tens, hundreds, or thousands of attributes that are considered relevant to a consumer's preferences and willingness to purchase a product. The number of attributes may be selected or determined empirically based on a given application. Each of the attributes may be assigned a numerical value ranging from zero to nine. Accordingly, an exemplary data vector may be a 100 digit sequence, and each digit may possess a numerical value equal to 0, 1, 2, 3, 4, 5, 6, 7, 8 or 9.

As described above, each digit in the sequence represents a normalized attribute of the social network user. In an illustrative sequence, the first digit of a social network user's Person Shopping Genome Sequence may represent the characteristic “owns a mobile communication device.” The first digit of the user's Person Shopping Genome Sequence would be determined based on communications between the user and the user's social network. The process for assigning a value to this digit may involve analyzing natural language in a stored communication from the user, which states “I am excited about my new mobile phone.” A software program using artificial intelligence and semantic algorithms may be used to analyze the user's stored communications and the communications of the user's contacts in the Social Raw Data Repository to extract the relevant information from that communication; namely, that the user is excited about having a new mobile phone, and thus “owns a mobile communication device.” The software program then may assign the first digit of the social network user's Person Shopping Genome Sequence a numerical value of 1 to indicate that the user owns a mobile communication device. In a similar manner, the values of each digit of an n-dimensional Person Shopping Genome Sequence that corresponds to n characteristics of the user may be determined.

The Person Shopping Genome Sequence Repository 20 may be populated by an automated software program. The automated software program may be executed on a general purpose computer that is controlled by a single user. The automated software program may utilize an Artificial Intelligence and Semantic Engine to create and update the individual Person Shopping Genome Sequences in the Person Shopping Genome Sequence Repository.

Accordingly, the Person Shopping Genome Sequence Repository 20 may be a database of sequences that are associated with the social network users in the Social Raw Data Repository. Each sequence (or Person Shopping Genome Sequence) may be a data vector that associates a set of numerical values with ordered attributes for one social network user based on information in the Social Raw Data Repository. For instance, each data vector may include tens, hundreds, or thousands of attributes that are considered relevant to a consumer's preferences and willingness to purchase a product. The number of attributes may be selected or determined empirically based on a given application. Each of the attributes may be assigned a numerical value ranging from zero to nine. Accordingly, an exemplary data vector may be a 100 digit sequence, and each digit may possess a numerical value equal to 0, 1, 2, 3, 4, 5, 6, 7, 8 or 9.

Genome Annotation Data (GAD) are data which are broadly related to a user's behavior, aspirations, preferences, interactions, and relationships but typically are not included in the user's Person Shopping Genome Sequence. For example, GAD relating to a user's behavior may include information that the user spent 0.33 seconds viewing an iPhone suggestion. In another example, GAD relating to a user's wishes or aspirations may include information that the user “has an iPhone” and “would love an iPad.” In yet another example, GAD relating to a user's behavior may be information that the user is currently in a bank. In yet another example, GAD relating to a user's relationships may be information that the user has a new niece. In yet another example, GAD relating to a user's behavior may include learned weighting factors for the vector components of the user's Person Shopping Genome Sequence.

GAD Engine 48 is a process for periodically obtaining GAD, which as described above, may include potentially relevant information concerning users of a social network that relate to a user's preferences or activities but does not affect the Personalized Shopping Genome Sequence of that user. The process involves capturing and analyzing communications exchanged between a user of a social network and the user's contacts. The process involves storing the information in a database called the GAD Repository 24. The GAD Engine also may capture and save information from the user's contacts' newsfeeds. In another example, the GAD Engine may capture and save information about a user's wishes or aspirations by analyzing an Internet store wishlist (e.g., an Amazon wishlist) that is associated with the user. In another example, the GAD Engine may capture and save information about a user's purchase history at an Internet store (e.g., Amazon purchase history). In yet another example, the GAD Engine may collect information about interaction choices and timings from the user's personalized store. Accordingly, the GAD Engine may collect user interaction choices and timings that unobtrusively extract evidence that a user favors (or disfavors) specific products or classes of products.

GAD Repository is a database that contains GAD from the GAD Engine and the AI and Semantic Engine. For example, the GAD repository may contain captured and filtered communications between users of a social network. Additionally, the GAD Repository may include learned weighting factors for vector components of a user's Person Shopping Genome Sequence. In another example, the GAD Repository may contain information about a user's wishes or aspirations based on analysis of an Internet store wish list (e.g., an Amazon wish list). Moreover, the GAD Repository may contain information about a user's purchase history at an Internet store (e.g., Amazon purchase history). In yet another example, the GAD Repository may contain information about interaction choices and timings from a user's personalized store. Further still, the GAD Repository may contain information that the user is currently in a bank or that the user has a new niece.

Additionally, the GAD Repository may contain data structures that describe the possible relations and connections between PSGS vectors and PGS vectors. The information in the GAD Repository may be updated (in whole or in part) periodically by the GAD Engine or AI and Semantic Engine. For instance, the database may be updated daily, weekly or at a selected time.

A non-limiting exemplary structure of Genome Annotation Data may be as follows: Person Shopping Genome ID, Item Shopping Genome ID, Record Type, Value, Date. In this example, the column “Person Shopping Genome ID” refers to a Person Shopping Genome that is associated with a particular user. The column “Item Shopping Genome ID” refers to a Product Genome Sequence that is associated with a particular product being offered for sale. The column “Record Type” refers to a parameter of interest for the user and the particular product being offered for sale. The column “Value” is a measure (or expression) of the state of relationship for the parameter of interest. The column “Date” refers to the calendar date that the data in the “Value” column were stored.

GAD may be stored in the GAD Repository in lines whose arguments correspond with the parameters associated with each column of the data structure. For example, one line of data that may be stored in the GAD Repository for the data structure described above may be as follows: 23, 21, likes, yes, Feb. 2, 2012. This line of information describes the relationship between the user associated with Person Shopping Genome ID #23 and the product associated with the Product Genome Sequence #21. The Record Type is “likes” (or product affinity), the “Value” (or argument for the Record Type) is yes, and the “Date” (or date of data entry) is Feb. 2, 2012.

In another example, the line of data may be as follows: 23, 21, has, yes, Feb. 2, 2012. This line of information describes the relationship between the user associated with Person Shopping Genome ID #23 and the product associated with the Product Genome Sequence #21. The Record Type is “has” (or product ownership), the “Value” (or argument for the Record Type) is yes, and the “Date” (or date of data entry) is Feb. 2, 2012.

In another example, the line of data may be as follows: 23, 21, viewduration, 0.33, 2/2/2012. This line of information describes the relationship between the user associated with Person Shopping Genome ID #23 and an offer for sale of the product associated with the Product Genome Sequence #21. The Record type is “viewduration” (or the elapsed time in milliseconds (ms) a user views the offering), the “Value” (or argument for the Record Type) is yes, and the “Date” (or date of data entry) is Feb. 2, 2012.

In yet another example, the line of data may be as follows: 23, NA, currentlocation, Bank-213ElmST_{—}94301, 2/2/2012. This line of information describes the relationship between the user associated with Person Shopping Genome ID #23 and the user's location. The Record Type is “currentlocation” (or the current location of the user), the Value (or argument for the Record Type) is Bank-213ElmST_{—}94301, and the Date (or date of data entry) is Feb. 2, 2012.

In yet another example, the line of data may be as follows: 23, 21, learningAlg1, −0.45, 2/2/2012. This line of information describes the relationship between the user associated with Person Shopping Genome ID #23 and the product associated with the Product Genome Sequence #21. The Record Type is “learningAlg1” (or the learned weight for recommendation algorithm 1), the Value (or argument for the Record Type) is −0.45, and the Date (or date of data entry) is Feb. 2, 2012.

As shown in FIG. 1, merchants are Internet websites that advertise, broker or sell goods and services online Merchants may advertise and sell their products directly from an online store or indirectly through the websites of online merchant aggregators. Merchant aggregators promote products from numerous merchants, manufacturers or service providers. Generally, merchant aggregators are compensated for brokering a product sale between an online shopper and an originating merchant.

Merchant Raw Data Extractor 50 is a process for periodically obtaining advertising and sales information from Internet merchants for a targeted list of products. This process periodically searches the Internet and stores web pages from a number of online merchants (e.g., Amazon or eBay) to create a merchant raw data set. The stored web pages contain advertising information about products offered by the respective merchants. For example, one web page from an online retailer may include the product name, manufacturer, model number, class of goods or services, price, and a digital image. This information is stored in a Merchant Raw Data Repository database. This process may be performed by an automated software program that is controlled by a single user. Additionally, the automated software program may utilize an AI and Semantic Engine to identify, extract merchant pricing and associated information that is stored in the Merchant Raw Data Repository.

Merchant Raw Data Repository 52 is a database that contains normalized merchant pricing and other relevant information from the merchant raw data set. The normalized information in the Merchant Raw Data Repository may be updated (in whole or in part) as new merchant raw data sets are collected by the Merchant Raw Data Extractor. For instance, the database may be updated periodically during the day or at a selected time.

Price List Normalization Engine 54 is a process that analyzes the information stored in the Merchant Raw Data Repository and transforms this information into normalized pricing data for selected merchants and products. The Price List Normalization Engine may access the Merchant Raw Data Repository, analyze the web pages stored therein, and extract certain information from the stored web pages, and create a normalized data structure from the information.

For instance, Price List Normalization Engine 54 may create a merchant price look up table for selected products and merchants based on an analysis of the merchant raw data that are stored in the Merchant Raw Data Repository 52. Normalized data structures, such as merchant price look up tables, may be stored in the Merchant Product's Price List Repository 18. For example, the Merchant Product's Price List Repository may contain updated prices for the “Top 100” products advertised for sale by a selected sample of merchants.

Moreover, other information extracted from the merchant raw data set, which are considered relevant to completing an online transaction between the merchants and an online customer, may be extracted, normalized and saved in a data structure in the Merchant Product's Price List Repository 18. For example, the respective shipping terms and pricing may be extracted from the merchant raw data set, normalized and housed in the Merchant Product's Price List Repository. This process may be performed by an automated software program that is controlled by a single user. Additionally, the automated software program may utilize an AI and Semantic Engine to identify, extract, and normalize merchant pricing and associated information that is stored the Merchant Product's Price List Repository.

Merchant Price List Repository 18 is a database that contains normalized merchant pricing and other relevant information from the Merchant Raw Data Repository. The normalized information in the Merchant Price List Repository may be updated (in whole or in part) as new merchant raw data sets are collected by the Merchant Raw Data Extractor. For instance, the Price List Normalization Engine may update the normalized information in Merchant Price List Repository periodically during the day or at a selected time.

Recommendation, Advertising and Personalization (RAP) Engine 28 is a process that analyzes data from the Product Genome Sequence Repository 20, Person Shopping Genome Sequence Repository 22, Merchant Product's Price List Repository 18, and Genome Annotation Data Repository 24 (“the four cylinders”). Based on these analyses, the process interacts with users of a social network to recommend and facilitate personalized purchasing opportunities for selected products in the Merchant's Price List Repository. The process may further recommend and facilitate the resale of a user's goods as part of the purchasing opportunity.

The Recommendation Advertising and Personalization Engine (“RAP Engine”) 28 may include three or more paradigms for recommending products to users. On the most basic level, it may work on the Four Cylinders to calculate and determine whether there is a product in the merchant database that is suitable for a user of the social network. It also may work on the Four Cylinders to calculate and determine whether there is a product in the database that is suitable for a social network contact of the user. Moreover, the RAP Engine may operate on the Four Cylinders to calculate and determine whether there is a suitable product for another user in the social network that is not a contact of the user based on a comparison of the respective Person Shopping Genome sequences of the two users.

The recommended purchasing opportunities may be generated through weighted distance search calculations involving Person Shopping Genome Sequences and Product Genome Sequences. The weighted distance search calculations may include weighting factors for the vector components. Additionally, recommended transactional opportunities may be based on a weighted distance search between two Product Genome Sequences (i.e., item-based collaborative filtering) or between two Person Shopping Genome Sequences (i.e., user-based collaborative filtering).

For example, a first item-based collaborative filtering calculation may be performed by the RAP Engine that involves calculating a distance between a first Product Genome Sequence and a second Product Genome Sequence, the distance being a function of the differences between the n characteristics of the first Product Genome Sequence and the second Product Genome Sequence. The distance calculation may include the application of a weighting factor. The RAP Engine may then recommend the second product to a user based on the user's known affinity toward the first product and the magnitude of the distance. Thus, if a User 1 owns Product A, and Product B is close to Product A on some dimensions, the RAP Engine may recommend Product B to User 1.

A second item-based collaborative filtering calculation may be performed by the RAP Engine that involves calculating a first distance between a source Product Genome Sequence and a first Product Genome Sequence, the first distance being a function of the differences between the n characteristics of the source Product Genome Sequence and the first Product Genome Sequence. The first distance calculation may include the application of a weighting factor. The RAP engine may further calculate a second distance between the source Product Genome Sequence and a second Product Genome Sequence, the second distance being a function of the differences between the n characteristics of the source Product Genome Sequence and the second Product Genome Sequence. The second distance calculation may include the application of a weighting factor. The RAP Engine may recommend a product based on the magnitude of the first distance and the second distance.

In another example, a first user-based collaborative filtering calculation may be performed by the RAP Engine that involves calculating a distance between a first Person Shopping Genome Sequence and a second Person Shopping Sequence, the distance being a function of the differences between the n characteristics of the first Person Shopping Genome Sequence and a second Person Shopping Sequence. The distance calculation may include the application of a weighting factor. The RAP Engine may then recommend a product associated with the first user to the second user based on the magnitude of the distance. Thus, if a User 1 owns Product A, and the distance between the Person Shopping Genome Sequences of User 1 and User 2 is close on some dimensions, the RAP Engine may recommend Product A to User 2.

In another example, a content filtering calculation may be performed by the RAP Engine based on the purchase history (or demonstrated affinity) of a group of n users for a product. The calculation is based on the inference that elements common to the Person Shopping Genome Sequence of the n users define a Product Affinity Genome Model. The premise of the model is that other users who share the elements of Product Affinity Genome Model will share the group's interest in the product. The calculation may further involve sampling k randomly selected users who did not like the product, and removing globally similar elements identified in that population from the Product Affinity Genome Model. The resulting Product Affinity Genome Model then may be considered a unique signature of the Person Shopping Genome Sequence for that product. Then, the RAP engine may calculate the distance between an n+1 user's Person Shopping Genome Sequence and the Product Affinity Genome Model. Based on the magnitude of the distance between the n+1 user's Person Shopping Genome Sequence and the Product Affinity Genome Sequence, the RAP Engine may recommend the product to the n+1 user.

FIG. 2 shows continuous data analysis for the system architecture. In section 1 of FIG. 2, social networks are continuously polled for new data. If either the system's user or the user's friend gets new data on their social network, the block 1 process is triggered, resulting in updated Person Shopping Genomes and GAD. In section 2 of FIG. 2, product sites are continuously monitored for new products and new information or reviews on known products. When new information is uncovered, analysis is triggered, resulting in updated Product Shopping Genomes and GAD. In section 3 of FIG. 2, merchant catalogs are continuously monitored for changes. When new information is uncovered, the analysis is triggered, resulting in updated price lists, Product Shopping Genomes, and GAD.

FIG. 3 shows process flows for differing aspects of the RAP Engine 28. In one aspect, the RAP Engine may operate on the results of continuous data analysis 26 to generate and display proactive product (or item) recommendations 58. For instance, the Recommendation Engine Architecture allows the system to interact with users of a social network and to recommend to them targeted purchasing opportunities. In this instantiation, the focus of the RAP Engine is to work on the Four Cylinders, to calculate, and determine whether there are products in the product database that may be suitable for a given user.

In another aspect, the RAP Engine 28 may operate on the results of continuous data analysis 26 to generate and display targeted advertising 60. For instance, the Advertising Engine Architecture allows the seller of a particular set of products to advertise those products to users with matching genomes. In this instantiation, the focus of the RAP Engine is to work on the Four Cylinders, to calculate, and determine whether there are users in the user database that are suitable for the seller's products.

In yet another aspect, the RAP Engine 28 may operate on the results of continuous data analysis 26 to generate and display personalized information 62. For instance, the Personalization Engine Architecture allows a merchant with a large set of products to provide a personalized shopping experience to a particular user. In this instantiation, the focus of the RAP Engine is to work on the Four Cylinders to rate the suitability of each product in the product set to the user. Then, a diverse set of highly suitable products may be displayed prominently to the user. By contrast, products with little or no suitability may be hidden from the user.

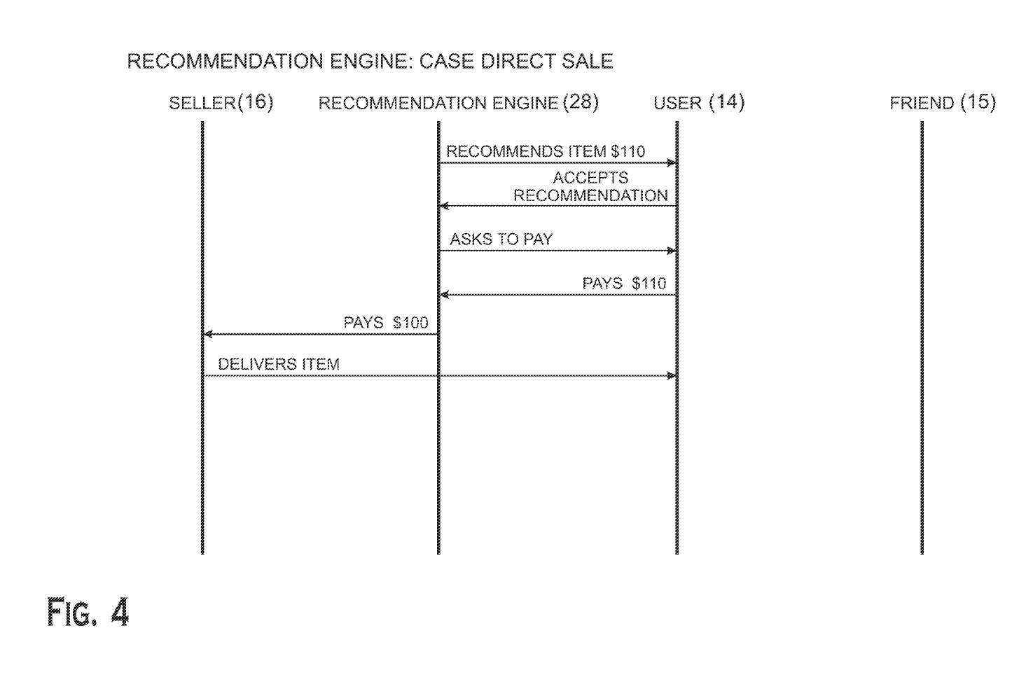

Referring to FIG. 1, the system architecture 10 may allow the RAP Engine 28 to recommend or offer a product transaction to a social network user based on an assessment that the user's Person Shopping Genome Sequence indicates a high likelihood that the user would be interested in purchasing that product. The product may be intended as a purchase for the social network user or as a gift for a contact of the social network user based upon their relationship with the user and the Person Shopping Genome Sequence of the contact. In the example illustrated in FIG. 4, the RAP Engine sends a recommendation to a user to purchase an item for $110. The user accepts the recommendation, receives a request from the RAP Engine to pay for the item, and then pays $110 to the RAP Engine. The RAP Engine pays the seller of the item $100, and the seller delivers the item to the user.

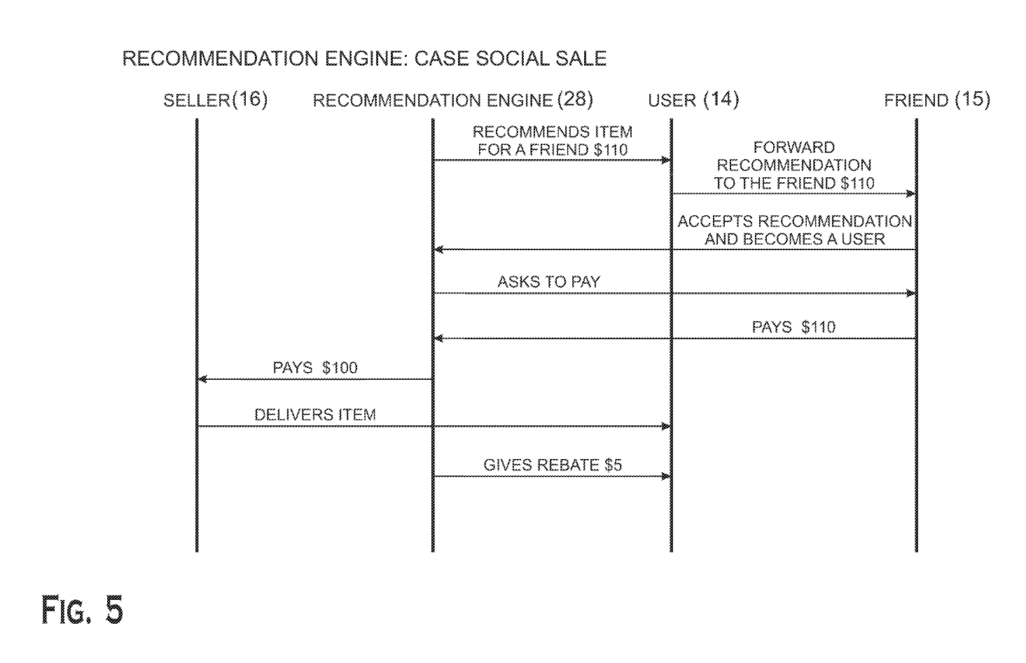

Referring to FIG. 1, the system architecture 10 may allow the RAP Engine 28 to send a product purchase recommendation to a social network user on behalf of one of the social network user's contacts (i.e., a recommendation for a social sale). This recommendation may be based on similarities between the Person Shopping Genome Sequence of the user and the user's contact or the recommendation may be based upon another distance search technique implemented by the RAP Engine. In the example illustrated in FIG. 5, the RAP Engine sends a user a product recommendation for a friend that costs $110. The user forwards the recommendation to the friend. The friend accepts the recommendation and becomes a user. The RAP Engine requests payment for the product in the amount of $110, and the friend pays $110 to the RAP Engine. The RAP Engine pays $100 to the seller of the recommended product, and the seller delivers the item to friend. The RAP Engine transfers $5 dollars to the user for helping complete the transaction.

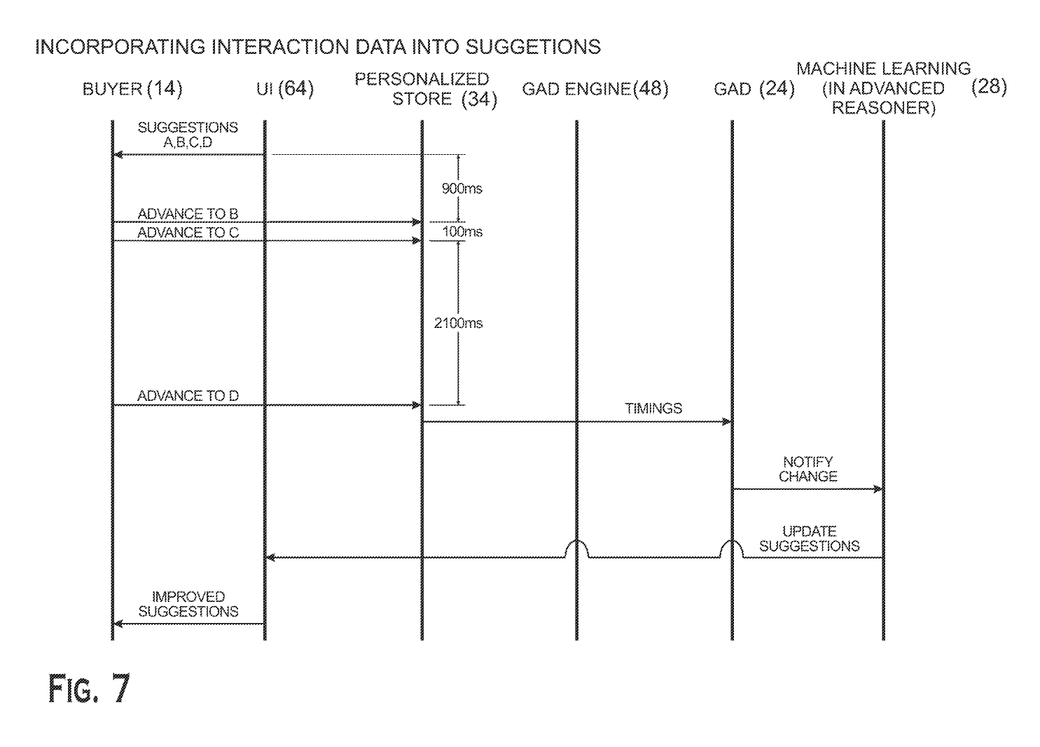

Referring to FIG. 1, the system architecture 10 may allow the RAP Engine 28 to interact with a social user through a web based application (or application for a mobile communication device). The RAP Engine may provide product recommendations based on active feedback from the user relating to one or more initial recommendations sent to the user in the context of providing a personalized store 34 or shopping assistant. In the example shown in FIG. 7, a user of the system accesses a personalized store via a user interface (UI) 64. During the user's shopping session, the user interface send a request to the user (or buyer) requesting permission to incorporate the user's purchase history and wish lists from an e-commerce site into the process of formulating product recommendations for the user. The user grants permission for this request and the GAD Engine requests the information from the e-commerce site. The user's purchase history and wish lists are returned to the system and stored in the GAD Repository. The RAP Engine (or advanced reasoner) is notified of the new information, which then determines an updated set of recommendations for display on the user interface. The user interface transfers the updated suggestions to the user.

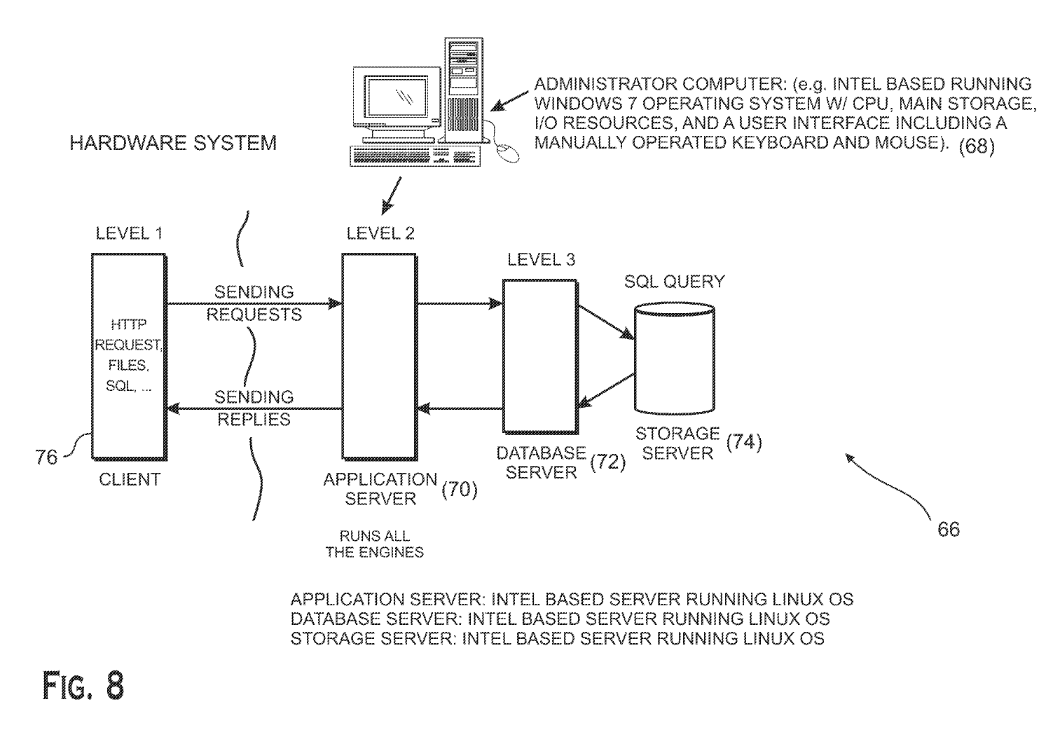

Referring to FIG. 8, the user's 14 interaction with the product recommendations on the user interface 64 are monitored by the GAD Engine 48 and then used by the RAP Engine 28 (or machine learning in advanced reasoner) to refine the product offerings. For example, suggestions A,B,C and D are presented to the user (or buyer) on the user interface. The time elapsed for the user to advance through the suggestions are measured and sent to the GAD Engine which then stores the information in the GAD Repository. The RAP Engine is notified of the new information and then determines an updated set of product suggestions for display to the user on the user interface.

Referring to FIG. 9. Exemplary hardware 66 for implementing the system may include an administrator computer 68, a Level 2 application server 70 connected to the administrator computer and the internet, a Level 3 database server 72, and a SQL Query storage server 74. The administrator computer may be Intel-based running Windows 7 operating system with CPU, main storage, I/O resources, and a user interface including a manually operated keyboard and mouse. The application, database, and storage servers, respectively, may be an Intel-based server running Linux operating system. The application server 68 may be connected to Level 1 clients 76 via the Internet and/or other network(s).

In use, the apparatus and system of FIG. 1 may be used for marketing of targeted goods and services to selected users of an Internet based social media community. More particularly, this invention relates to an apparatus, system and method of collecting communications exchanged by users of an Internet-based social media community, generating a collection of normalized purchase decision profiles for each of those users, researching market conditions for a set of goods and services, and transforming these data into individually customized direct marketing offers to buy or sell goods and services to those users and their social network contacts.

For example, the RAP Engine may make a direct recommendation to a user based on an analysis of data in the four cylinders: A social network user has a Facebook account. The social network user has 130 social network contacts (or Friends) associated with the account. One year ago the social network user purchased an iPhone 4. The social network user posted a communication to the contacts in the user's social network stating that the user “is very happy with his new iPhone 4 purchase.” Soon afterward, the social network user scratches the glass cover of the device, and posts a communication to the user's contacts in the social network that “his phone fell out of his pocket on a recent business trip, scratching the front glass cover of the device.” The Social Raw Data Extractor saves potentially relevant parts of the webpage with this post to the Social Raw Data Repository. The AI and Semantic Engine analyze the communication, determine that the user owns a damaged iPhone 4, and update the user Personal Shopping Genome Sequence to reflect that the user owns a mobile communication device, that the product brand is Apple®, and that the product model is an iPhone 4. Based on an analysis of the user's Personal Shopping Genome Sequence and the Product Genome Sequence Repository, the RAP engine sends the user a recommendation to buy an iPhone 4S.

In another example, the RAP Engine evaluates the user's Personal Shopping Genome Sequence and finds that the user owns a mobile communication device, that the product brand is Apple®, that the product model is an iPhone 4, that the mobile communication device was purchased one year ago, and that it is damaged. Based on an analysis of the user's Personal Shopping Genome Sequence and the Product Genome Sequence Repository and the other cylinders, the RAP engine sends the user a recommendation to buy a cover for the iPhone 4.

In another example, a user purchases a new application for the mobile communication device. The user posts a communication to the contacts in the user's social network stating that the user “has a useful nutrition application that helped me improve my average pace for running a marathon by 30 seconds per mile.” Based on an analysis of the Personal Shopping Genome Sequences of the user and the user's social network contacts and the data in the Product Genome Sequence Repository and the other cylinders, the RAP engine sends the user an invitation to recommend the new application to one of the user's social network contacts, who enjoys swimming and owns a similar device, but does not use this application.

In another example, a user is aware of an upcoming birthday of a social network contact. The user posts a communication to contacts in the user's social network stating that “I have no idea what to get Jamie for her birthday.” Based on an analysis of the Personal Shopping Genome Sequences of the user's social network contacts, the data in the Product Genome Sequence Repository and the other cylinders, the RAP engine sends the user a recommendation to purchase the social network contact a massage and facial treatment service for a gift.

While it has been illustrated and described what at present are considered to be preferred embodiments of the present invention, it will be understood by those skilled in the art that various changes and modifications may be made, and equivalents may be substituted for elements thereof without departing from the true scope of the invention. Additionally, features and/or elements from any embodiment may be used singly or in combination with other embodiments. Therefore, it is intended that this invention not be limited to the particular embodiments disclosed herein, but that the invention include all embodiments within the scope and the spirit of the present invention.

What is claimed is:

1. A system for marketing targeted products to users of an Internet-based social media community comprising:
a RAP Engine for generating product recommendations;
a Person Shopping Genome Sequence Repository connected to the RAP Engine;
a Product Genome Sequence Repository connected to the RAP Engine;
a Merchant Product's Price List Repository connected to the RAP Engine;
a Genome Annotation Data Repository connected to the RAP Engine;
an AI and Semantic Engine connected to the Genome Annotation Data Repository, the Product Genome Sequence Repository, and the Merchant Product's Price List Repository; and
a first data channel connected to the RAP Engine for communicating product recommendations to users of an Internet-based social media community.

2. The system of claim 1, further comprising a Social Raw Data Repository and a Product Raw Data Repository connected to the AI and Semantic Engine.

3. The system of claim 2, further comprising a Social Raw Data Extractor connected to the Social Raw Data Repository and a second data channel for accessing social data associated with users of the Internet-based social media community.

4. The system of claim 3, further comprising a Product Raw Data Crawler connected to the Product Raw Data Repository and a third data channel for accessing product data posted on the Internet.

5. The system of claim 4, further comprising a Merchant Raw Data Extractor connected to a fourth data channel for accessing merchant data posted on the Internet.

6. The system of claim 5, further comprising a Merchant Raw Data Repository connected to the Merchant Raw Data Extractor for storing extracted merchant data from the Internet.

7. The system of claim 6, further comprising a Price List Normalization Engine connected to the Merchant Raw Data Repository and the Merchant Product's Price List Repository which transforms extracted merchant data in the Merchant Raw Data Repository into normalized merchant pricing data for storage in the Merchant Product's Price List Repository.

8. The system of claim 7, wherein the transformation of extracted merchant data in the Merchant Raw Data Repository into normalized merchant pricing data comprises creating a merchant price look up table.

9. The system of claim 7, further comprising a GAD Engine connected to the Genome Annotation Data Repository and a fifth data channel for capturing social data associated with users of the Internet-based social media community.

10. The system of claim 9, further comprising a GAD Engine connected to the Genome Annotation Data Repository and a fifth data channel for capturing social data associated with users of the Internet-based social media community.

11. The system of claim 9, wherein the GAD Engine captures and analyzes communications between a user of the Internet-based social media community and a third party.

12. The system of claim 9, wherein the GAD Engine captures and analyzes an Internet store wishlist that is associated with a user of the Internet-based social media community.

13. The system of claim 9, wherein the GAD Engine captures and analyzes an Internet store purchase history that is associated with a user of the Internet-based social media community.

14. The system of claim 10, further comprising a Personalized Store for a user of the Internet-based social media community which is populated by a plurality of products recommended by the RAP Engine based on distance search calculations involving data stored in the Person Shopping Genome Sequence Repository, the Product Genome Sequence Repository, the Merchant Product's Price List Repository, and the Genome Annotation Data Repository.

15. The system of claim 14, wherein the Personalized Store comprises a user interface for communicating with a user of the Internet-based social media community such that the user interface monitors the user's interaction with the plurality of products populating the Personalized Store and transmits information to the GAD Engine concerning the user's interaction with the plurality of products to provide additional data for updating product recommendations generated by the RAP Engine.

16. The system of claim 1, wherein the RAP Engine is configured and adapted to perform distance search calculations involving data stored in the Person Shopping Genome Sequence Repository, the Product Genome Sequence Repository, the Merchant Product's Price List Repository, and the Genome Annotation Data Repository.

17. The system of claim 16, wherein the Person Shopping Genome Sequence Repository houses a first Person Shopping Genome Sequence and a second Person Shopping Genome Sequence, and the RAP Engine is configured and adapted to perform distance search calculations which comprise calculating a first distance between the first Person Shopping Genome Sequence and the second Person Shopping Genome Sequence.

18. The system of claim 16, wherein the Person Shopping Genome Sequence Repository houses a plurality of Person Shopping Genome Sequences, and the RAP Engine is configured and adapted to perform distance search calculations which comprise calculating a Product Affinity Genome Model, and calculating a second distance between one of the plurality of Person Shopping Genome Sequences and the Product Affinity Genome Model.

19. The system of claim 1, wherein the RAP Engine is configured and adapted to analyze information from continuous data analysis and generate product recommendations that are tailored to a user's situation.

20. The system of claim 1, wherein the RAP Engine is configured and adapted to analyze information from continuous data analysis and generate product recommendations that are tailored to a social sale.
